(19) United States
(12) Patent Application Publication
(10) Pub. No.: US 2015/0314300 A1
(43) Pub. Date: Nov. 5, 2015

(54) CRUSHER FEED HOPPER WEAR PROTECTION CASSETTE

(71) Applicant: SANDVIK INTELLECTUAL PROPERTY AB, Sandviken (SE)

(72) Inventors: Patric MALMQVIST, Svedala (SE); Mikael M. LARSSON, Eslov (SE); Fredrik ERIKSSON, Malmo (SE); Bengt-Arne ERIKSSON, Svedala (SE); Axel BERGMAN, Malmo (SE)

(21) Appl. No.: 14/441,433

(22) PCT Filed: Oct. 8, 2013
(86) PCT No.: PCT/EP2013/070867

§ 371 Date: May 7, 2015

(30) Foreign Application Priority Data
Nov. 8, 2012 (EP) 12191767.8

(51) Int. Cl. B02C 23/02; B02C 2/00

(52) U.S. Cl. CPC B02C 23/02; B02C 2/007; B02C 2/005

(57) ABSTRACT

A crusher feed hopper wear protection cassette to mount at a wall of a crusher hopper. The cassette includes a mount member to contact and releasably mount the cassette at a region of the feed hopper and a support face to mount at least one wear liner orientated to be facing the interior region of the hopper chamber.

### FIELD OF INVENTION

The present invention relates to a crusher feed hopper wear protection cassette and in particular, although not exclusively, to a cassette mountable at a crusher feed hopper capable of mounting wear liners to protect the hopper wall and capable of being removed from the hopper conveniently for maintenance and replacement of the wear liners or other hopper components.

### BACKGROUND ART

Gyratory crushers are used for crushing ore, mineral and rock material to smaller sizes. Typically, the crusher comprises a crushing head mounted upon an elongate main shaft. A first crushing shell is mounted on the crushing head and a second crushing shell is mounted on a frame such that the first and second crushing shells define together a crushing gap through which material to be crushed is passed. A driving device positioned at a lower region of the main shaft is configured to rotate an eccentric assembly about the shaft to cause the crushing head to perform a gyratory pendulum movement and crush the material introduced in the crushing gap. Example gyratory crushers are described in WO 2004/110626; WO 2010/123431and WO 2012/005651.

Similarly, vertical shaft impact crushers (VSI-crushers) are used in many applications for crushing hard material like rocks, ore etc., with examples described in WO 2004/020103 and WO 2010/042025.

Common to the various types of crushers is the need for the controlled feeding of material into the crusher in order to optimise the crushing action and crusher efficiency. Typically, a feed hopper is mounted at the crusher inlet and acts to guide material into the crushing zone. To reduce damage and wear to the hopper walls replaceable wear protection liners are usually mounted within the hopper chamber.

Conventionally, this wear protection is mounted directly on the inner surface of the feed hopper wall which requires mounting holes extending through the wall. These holes have been found to create stress concentrations and enhanced wear of the hopper. Additionally, to repair or replace sections of the protection liner, engineers are typically required to climb inside the feed hopper and work in an unpleasant and dusty environment. Disassembly of the hopper from the crusher is therefore a more attractive option for maintenance. However, this requires significantly longer disruption times due to the detachment and reattachment of the hopper (and various other components) requiring the use of additional lifting apparatus. What is required is a crusher hopper and in particular wear protection apparatus that address the above problems.

### SUMMARY OF THE INVENTION

It is an object of the present invention to provide a crusher feed hopper and wear protection apparatus that allow quick and convenient repair and replacement of protective wall liners at an interior region of the crusher hopper. It is a further objective to minimise disruption to the crushing operation resultant from the down-time of the crusher due to the necessary maintenance work.

Accordingly, the inventors provide wear protection apparatus for installation within a feed hopper that functions as an intermediate support for the wear protection liners. The present wear protection apparatus is formed as a cassette that may be readily removed and replaced at the hopper interior to provide convenient access to the worn liners and allow rapid repair and/or replacement. The present cassette apparatus is advantageous in numerous respects including in particular i) the avoidance of personnel having to physically climb into and work within the hopper ii) the reduction, as far as possible, of the time required for maintenance work and the down-time of the crushing operation and iii) the avoidance of heavy lifting apparatus used to physically remove the entire hopper to undertake the maintenance work.

The present wear protection cassette is configured to be mounted conveniently at an upper region of the hopper and correct alignment is ensured by interengaging members present on both the cassette and the hopper. This is advantageous to obviate any misalignment and provides an efficient and reliable maintenance procedure.

According to a first aspect of the present invention there is provided a crusher feed hopper wear protection cassette to mount at least one wear liner at a crusher feed hopper, the cassette comprising: a main body for positioning at an interior region of the crusher feed hopper; the main body having a rear face for positioning in opposed relation to a wall of the feed hopper; a support face to mount at least one wear liner to be facing the interior region of the feed hopper; a mount member to contact and releasably mount the cassette at a region of the feed hopper.

Preferably, the cassette further comprises an alignment element to engage with a region of the feed hopper to provide a correct alignment of the cassette at the feed hopper. Optionally, the alignment element comprises at least one hole or notch formed in the mount member. Preferably, the alignment element comprises a first half of a male-female interengaging assembly, the second half of the assembly being provided on the feed hopper.

Preferably, the cassette further comprises attachment means to releasably attach the at least one wear liner at the support face. Optionally, the attachment means comprises at least one hole extending through the main body between the support face and the rear face and configured to receive an elongate mounting bolt or pin.

Preferably, the cassette comprises a plurality of support ribs projecting from the rear face to contact the wall of the feed hopper. Preferably, the mount member projects rearwardly from a region of the rear face and extends transverse or substantially perpendicular to the rear face.

Preferably, the main body comprises a plurality of plate-like bodies, each body having a pair of lengthwise edges, the plate-like bodies positioned with their lengthwise edges in touching or near touching contact to form a unified or near unified structure.

According to a second aspect of the present invention there is provided a set of crusher feed hopper wear protection cassettes to respectively mount at least one wear liner at a crusher feed hopper as described herein wherein: at least one cassette of the set comprises a main body positioned relative to the mount member according to a first positional configuration; and at least one cassette of the set comprises a main body positioned relative to the mount member according to a second positional configuration; such that at least one cassette with the first positional configuration may be considered a right-handed cassette and at least one cassette with the second positional configuration may be considered a left-handed cassette.

According to a third aspect of the present invention there is provided a modular crusher feed hopper for mounting upon a crusher, the feed hopper comprising: at least one wall defining an internal hopper chamber through which material to be crushed is fed to the crusher; the hopper having an uppermost end to be positioned furthest from the crusher, the uppermost end configured to provide a mounting region; characterised by: at least one wear protection cassette releasably mounted at the feed hopper at the region of the at least one wall, the at least one cassette comprising: a main body for positioning at an interior region of the crusher feed hopper; the main body having a rear face for positioning in opposed relation to the wall of the feed hopper; a support face to mount at least one wear liner to be facing the chamber of the feed hopper; a mount member to contact and releasably mount the cassette at or towards the uppermost end of the feed hopper.

Preferably, the uppermost end comprises a mounting rim aligned transverse to the at least one wall; and wherein the mount member comprises a shape profile to mount on top of the mounting rim. Preferably, the mount member comprises a first alignment element; and the mounting rim comprises a second alignment element configured to releasably engage with the first alignment element to provide a correct alignment of the at least one cassette at the feed hopper.

Optionally, the at least one wall comprises a frusto cone shaped profile such that the at least one wall is orientated to be inwardly projecting from an uppermost end to a lowermost end relative to a longitudinal axis of the hopper.

According to a fourth aspect of the present invention there is provided a crusher feed hopper for mounting upon a crusher comprising: at least one wall defining an internal hopper chamber through which material to be crushed is fed to the crusher; the hopper having an uppermost end to be positioned furthest from the crusher, the uppermost end configured to provide a mounting region for a hopper wall protection insert; characterised by: a plurality of guide lugs provided at a region of the uppermost end and configured to mate with regions of the protection insert to provide correct alignment and mounting of the protection insert at the hopper.

According to a fifth aspect of the present invention there is provided a crusher comprising a feed hopper as described herein and at least one cassette as described herein.

### BRIEF DESCRIPTION OF DRAWINGS

A specific implementation of the present invention will now be described, by way of example only, and with reference to the accompanying drawings in which:

FIG. 1 is an external side view of a hopper comprising a plurality of guide lugs positioned at an uppermost end, the hopper suitable for mounting upon a crusher according to a specific implementation of the present invention;

FIG. 2 is a perspective view of the uppermost end of the hopper of FIG. 1 at a region of the guide lugs;

FIG. 3 is a perspective view of the hopper of FIG. 1 with a plurality of wear protection cassettes mounting a plurality of wear protection liners at the internal chamber of the feed hopper according to a specific implementation of the present invention;

FIG. 4 is a perspective view of the set of wear protection cassettes and respective wear liners of FIG. 3;

FIG. 5 is a perspective view of a single cassette mounting a plurality of wear protection liners of FIG. 4;

FIG. 6 is a rear perspective view of the wear protection cassette of FIG. 5;

FIG. 7 is a front perspective view of the wear protection cassette of FIG. 6 without the protection liners;

FIG. 8 is a rear perspective view of the wear protection cassette of FIG. 7.

### DETAILED DESCRIPTION OF PREFERRED EMBODIMENT OF THE INVENTION

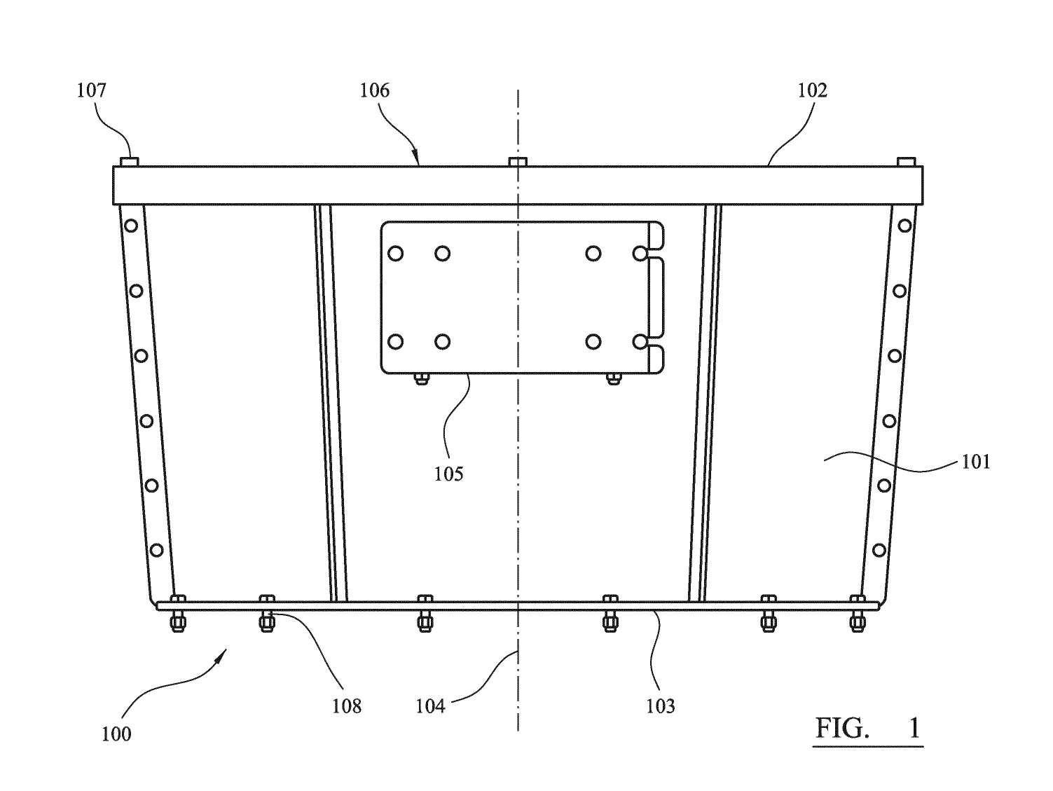

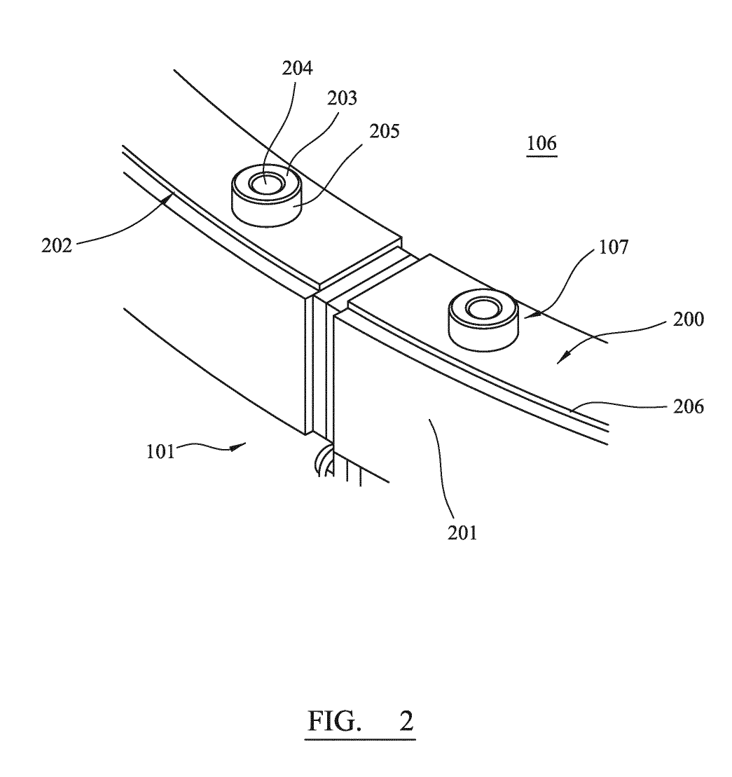

Referring to FIGS. 1 and 2, hopper 100 comprises a main hopper side wall 101 that extends circumferentially around a central longitudinal axis 104 of hopper 100. Wall 101 extends from an uppermost end 102 to a lowermost end 103 with end 103 suitable for mounting upon a crusher (not shown). Accordingly, uppermost end 102 is positioned furthest from the crusher (not shown). Hopper 101 is mounted at the crusher, or an intermediate component part, via mounting bolts 108 at lowermost end 103.

To assist with the directing and feeding of material to be crushed through hopper 100, hopper wall 101 is orientated to taper inwardly from uppermost end 102 towards lower end 103 relative to longitudinal axis 104. That is, relative to axis 104, wall 101 is tangential at an angle of substantially 5° to define a frusto cone shaped profile. Accordingly, a cross sectional area (relative to axis 104) of lowermost end 103 is less than a corresponding cross sectional area at uppermost end 102.

Wall 101 defines an internal hopper chamber 106 extending between uppermost and lowermost ends 102, 103. To allow access into chamber 106, a hatch 105 having a door and frame, is mounted at wall 101 being common to conventional crusher hoppers.

A plurality of guide lugs 107 projects upwardly from the uppermost end 102 and comprise a length that is aligned substantially with longitudinal axis 104. As detailed in FIG. 2, wall 101 is terminated at the uppermost end 102 by an annular rim 202 that also extends circumferentially around axis 104. Rim 202 projects radially outward from wall 101 and comprises an uppermost facing surface 200 that is terminated at its radially outermost edge 206 by a rim wall 201 that projects downwardly from edge 206 towards lowermost end 103. Rim wall 201 is aligned substantially parallel with axis 104 and comprises an axial length that slightly greater than the radial length of rim 202 and is orders of magnitude shorter than an axial length of hopper wall 101 between ends 102 and 103.

Each guide lug 107 comprises a substantially hollow cylindrical shape profile and projects upwardly from rim surface 200. The portion of each guide lug 107 that extends upwardly beyond rim surface 200 comprises a cylindrical wall 205 that is terminated by an upper annular face 203. A through bore 204 extends through the cylindrical body of guide lug 107 and is aligned substantially parallel with main axis 104.

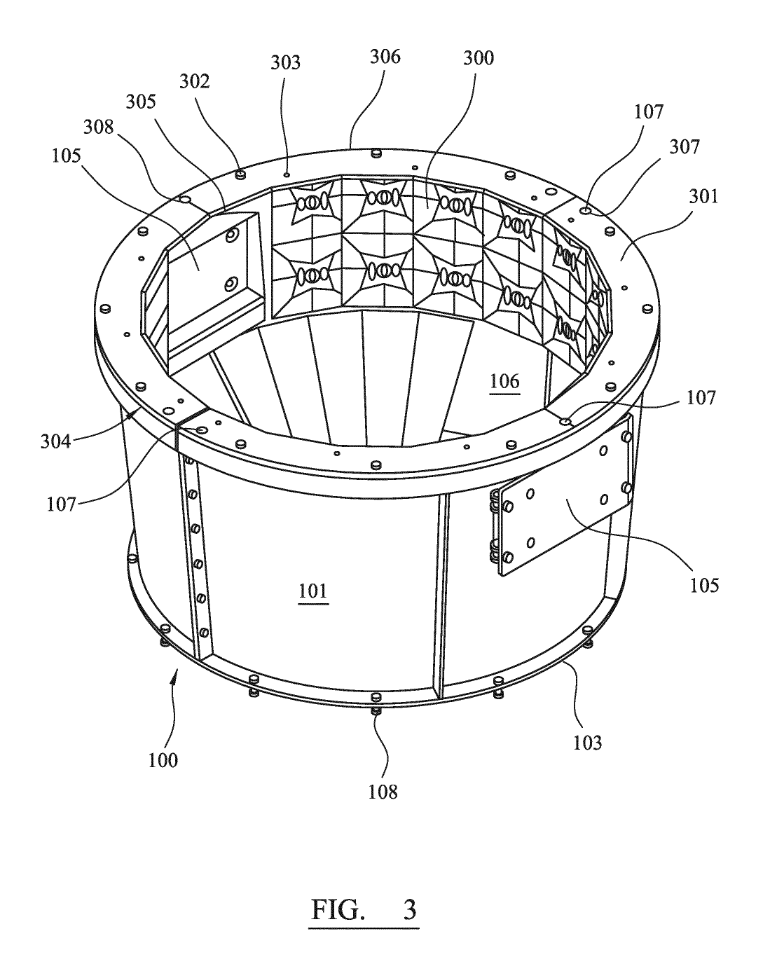

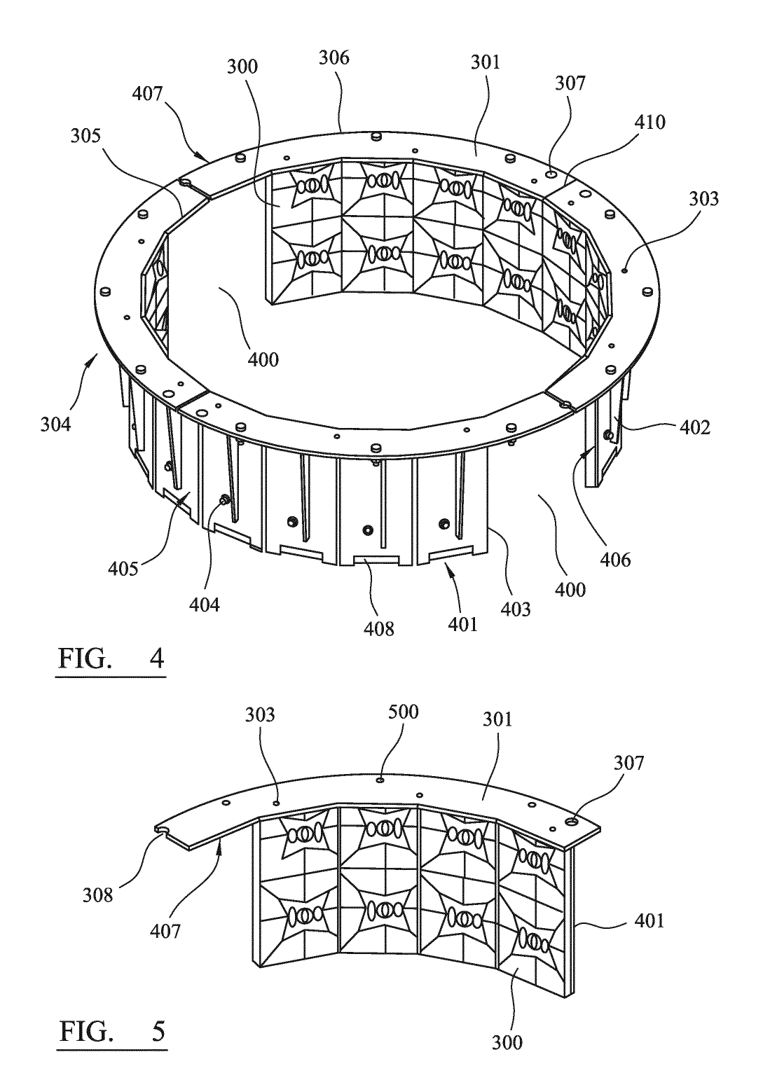

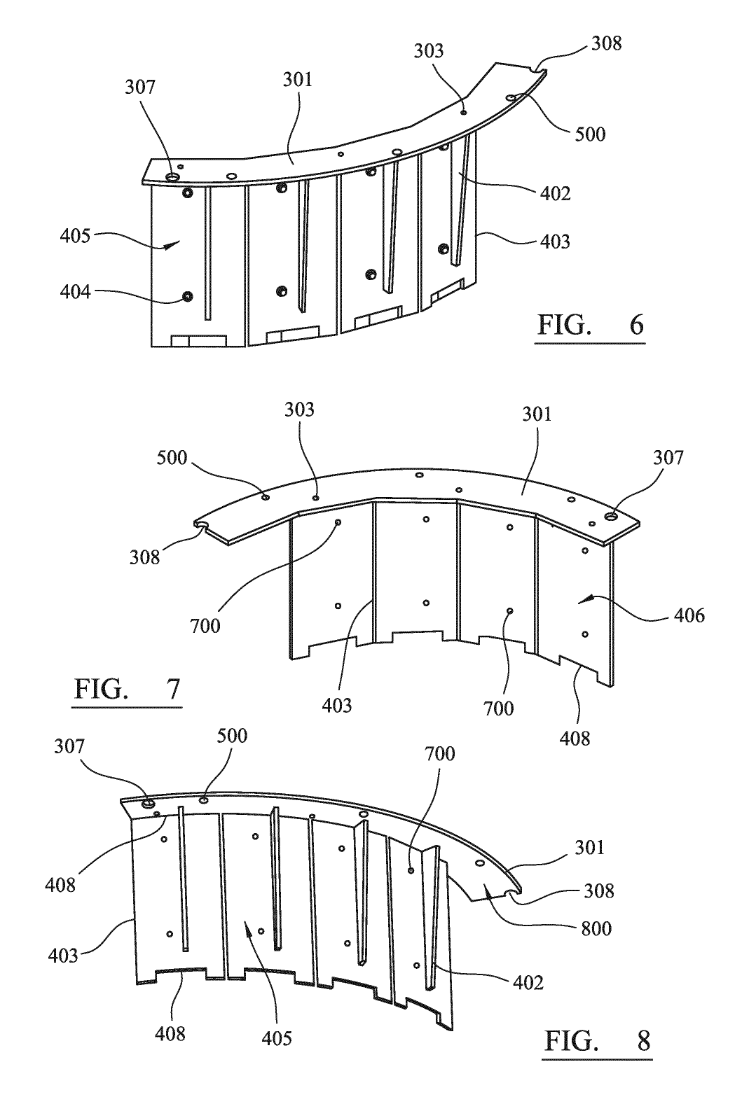

Referring to FIGS. 3, four wear protection cassettes 304 are mounted upon hopper 100 with the majority of each cassette 304 positioned within hopper chamber 106. Referring to FIGS. 4 to 8 each cassette comprises a main body formed by a plurality of plate-like bodies 401 and a mount member 301 formed as an arcuate substantially planar flange aligned perpendicular to the plate-like bodies 401. Each plate-like body 401 comprises a pair of lengthwise edges 403 and a pair of widthwise edges 408. Each flange 301 of each cassette 304 is connected to four plate-like bodies 401 at one of their widthwise edges 408. The arcuate flange 301 comprises an inner lengthwise edge 305 and an outer lengthwise edge 306 where a length of each edge represents one quarter of the annular circumference of rim 202. Additionally, flange 301 comprises a first widthwise edge 410 and a second widthwise edge 409. A width of each flange 301 between inner and outer edges 305, 306 is approximately equal to and slightly greater than a width of rim 200 such that flange 301 is mountable upon rim 200. Each of the four plate-like bodies 401 are positioned at or towards inner edge 305 such that the majority of the width of flange 301 extends rearwardly from a rear face 405 of plate-like bodies 401. Accordingly, an opposed support face 406 is orientated inwardly towards axis 104 within chamber 106.

A plurality of support ribs 402 project rearwardly from rear face 405 and extend the majority of the length of each plate-like body 401. Each rib 402 terminates at an underside surface 800 (referring to FIG. 8) of flange 301. Each rib 402 comprises a lengthwise tapering thickness such that a distance by which rib 401 extends from rear face 405 is greatest at the region where it contacts underside surface 800 of flange 301. This is advantageous to provide structural support between flange 301 and plate-like bodies 401 and also to facilitate correct alignment when cassette 304 is positioned against the inner surface of the frusto conical hopper wall 101.

To provide correct alignment and facilitate rapid mounting within hopper 100, each flange 301 comprises a hole 307 having a diameter slightly larger than a diameter of the cylindrical guide lug 107 such that guide lug 107 is capable of seating within each hole 307. Hole 307 is positioned towards (in close proximity to) edge 410. A corresponding notch 308 is also formed in each flange 301 and represents one half of a full hole 307. Notch 308 is recessed into edge 409. As illustrated in FIGS. 3 and 4, when each cassette 304 is mounted in position at hopper 100, the four notches 308, at edges 409, of each cassette 304 mate together to form two respective holes equivalent to holes 307 which each of the two holes fully surrounding two respective guide lugs 107.

Each flange 301 further comprises a plurality of threaded holes 303 to receive lifting eyelets to enable each cassette 304 to be lifted vertically from hopper 100. A plurality of fastener holes 500 also extend through each flange 301 to receive corresponding fastening bolts 302 to secure each cassette 304 to hopper 100.

A section 407 of flange 301 is devoid of the plate-like bodies 401 so as to create a gap 400 when the four cassettes 304 are assembled together circumferentially around axis 104 and mounted upon hopper rim 200. Gap 400 is suitable sized to allow access into the hopper chamber 106 through each hatch 105. As a result of the relative positioning of the plate-like bodies 401 at flange 301 (and in particular the relative position of section 407 versus the relative position of hole 307 and notch 308), two of the four cassettes 304 are considered right-handed and two cassettes 304 are considered left-handed. This configuration ensures that the right-handed cassettes are always positioned next to the left-handed cassettes via mating of the respective pairs of edges 410 and 409.

Each mount face 406 of each plate-like body 401 is substantially planar to mount a corresponding wear protection liner 300. Two bore holes 700 extend through each plate-like body 401 between faces 405 and 406. Each liner 300 is releasably secured to each face 406 via two corresponding attachment bolts 404 received through holes 700. As will be appreciated, releasable attachment of the wear liners 300 at each of the plate-like bodies 401 may be via any suitable means including bayonet, plug, pin, snap-fit or screw fit connections that allow for the rapid and convenient removal and attachment of the liners 300 at each respective face 406.

In use, the four cassettes 304 are positioned edge-to-edge (410, 409) around longitudinal axis 104 such that the plate-like bodies 401 extend within hopper chamber 106. Each cassette 304 is mounted at hopper 101 via engagement of the underside rim surface 800 on top off annular rim 200. Each rib 402 is positioned in contact with the inner surface of wall 101 and correct alignment is achieved as guide lugs 107 are received within the holes 307 and notches 308. With wear protection liners 300 mounted at each support face 406, each body 401 is positioned intermediate between liners 300 and the inner surface of hopper wall 101. When maintenance or replacement of one or a plurality of liners 300 is required, each cassette 304 may be independently lifted from hopper 100 via eyelet bolts received within holes 303. A damaged liner 300 may then be quickly and conveniently replaced via attachment mountings 404. The repaired cassette 304 is then lowered back into position quickly via alignment of guide lugs 107 within hole 307 and notches 308. The present cassette system therefore provides a convenient means for repairing and replacing damaged and worn liners 300.

1. A crusher feed hopper wear protection cassette to mount at least one wear liner at a crusher feed hopper, the cassette comprising:
a main body for positioning at an interior region of the crusher feed hopper;
the main body having a rear face for positioning in opposed relation to a wall of the feed hopper;
a support face to mount at least one wear liner to be facing the interior region of the feed hopper; and
a mount member to contact and releasably mount the cassette at a region of the feed hopper.

2. The cassette as claimed in claim 1, further comprising an alignment element to engage with a region of the feed hopper to provide a correct alignment of the cassette at the feed hopper.

3. The cassette as claimed in claim 2, wherein the alignment element includes at least one hole or notch formed in the mount member.

4. The cassette as claimed in claim 2, wherein the alignment element includes a first half of a male-female inter-engaging assembly, the second half of the assembly being provided on the feed hopper.

5. The cassette as claimed in claim 1, further comprising attachment means to releasably attach the at least one wear liner at the support face.

6. The cassette as claimed in claim 5, wherein the attachment means include at least one hole extending through the main body between the support face and the rear face and configured to receive an elongate mounting bolt or pin.

7. The cassette as claimed in claim 1, further comprising a plurality of support ribs projecting from the rear face to contact the wall of the feed hopper.

8. The cassette as claimed in claim 1, wherein the mount member projects rearwardly from a region of the rear face and extends transverse or substantially perpendicular to the rear face.

9. The cassette as claimed in claim 1, wherein the main body includes a plurality of plate-like bodies, each body having a pair of lengthwise edges, the plate-like bodies positioned with their lengthwise edges in touching or near touching contact to form a unified or near unified structure.

10. A set of crusher feed hopper wear protection cassettes to respectively mount at least one wear liner at a crusher feed hopper, the set comprising:
at least one cassette of the set including a main body positioned at an interior region of the crusher feed hopper, the main body having a rear face for positioning in opposed relation to a wall of the feed hopper; a support face to mount at least one wear liner to face the interior region of the feed hopper; and a mount member to contact and releasably mount the cassette at a region of the feed hopper, the at least one cassette being positioned relative to the mount member according to a first positional configuration; and
at least one cassette of the set including a main body positioned relative to the mount member according to a second positional configuration, such that the at least one cassette with the first positional configuration is a right-handed cassette and the at least one cassette with the second positional configuration is a left-handed cassette.

11. A modular crusher feed hopper for mounting upon a crusher, the feed hopper comprising:
at least one wall defining an internal hopper chamber through which material to be crushed is fed to the crusher;
an uppermost end positioned furthest from the crusher, the uppermost end being configured to provide a mounting region;
at least one wear protection cassette releasably mounted at the feed hopper at a region of the at least one wall, the at least one cassette including a main body for positioning at an interior region of the crusher feed hopper; the main body having a rear face for positioning in opposed relation to the wall of the feed hopper; a support face to mount at least one wear liner facing the chamber of the feed hopper; a mount member to contact and releasably mount the cassette at or towards the uppermost end of the feed hopper.

12. The feed hopper as claimed in claim 11, wherein the uppermost end comprises a mounting rim aligned transverse to the at least one wall; and
wherein the mount member includes a shape profile to mount on top of the mounting rim.

13. The feed hopper as claimed in claim 12, wherein the mount member includes a first alignment element; and the mounting rim includes a second alignment element configured to releasably engage with the first alignment element to provide a correct alignment of the at least one cassette at the feed hopper.

14. The feed hopper as claimed in claim 11, wherein the at least one wall has a frusto cone shaped profile such that the at least one wall is orientated to be inwardly projecting from the uppermost end to a lowermost end relative to a longitudinal axis of the hopper.

15. A crusher comprising,
a feed hopper 14, the feed hopper including at least one wall defining an internal hopper chamber through which material to be crushed is fed to the crusher; an uppermost end positioned furthest from the crusher, the uppermost end being configured to provide a mounting region; and
at least one cassette releasably mounted at the feed hopper at a region of the at least one wall, the at least one cassette including a main body for positioning at an interior region of the crusher feed hopper, the main body having a rear face for positioning in opposed relation to the wall of the feed hopper ; a support face to mount at least one wear liner facing the chamber of the feed hopper; a mount member to contact and releasably mount the cassette at or towards the uppermost end of the feed hopper
